(19) United States
(12) Patent Application Publication
(10) Pub. No.: US 2005/0132626 A1
(43) Pub. Date: Jun. 23, 2005

(54) Multi-layered sign with enhanced reflecting layer

(76) Inventor: William Yacob Ahmadi, Los Angeles, CA (US)

Correspondence Address: William Y. Ahmadi, P.O. Box 70328, Los Angeles, CA, 90070, US

(21) Appl. No.: 10/742,318

(22) Filed: Dec. 22, 2003

(51) Int. Cl. G09F 19/00

(52) U.S. Cl. 40/615

(57) ABSTRACT

A system and device to enhance the visibility of signs in low light conditions using multi reflective layers to enhance either ambient light or light induced through the front plate from external sources. The stacked layer consists of a clear layer of material through which light enters, on reaching the prismatic layer the light is enhanced and reflected through the graphic or wording of the sign

### FIELD OF INVENTION

This invention relates to a multi-layered sign. Specifically for the use of improving readability in low light condition

### BACKGROUND OF THE INVENTION

There are innumerable applications for simple signs. They may be attached to interior or exterior walls of homes or buildings, or suspended from overhead supports, or supported on purpose built structures. They may be used for example as: advertising, street signs, direction signs, or to identify a building or a room, or a service, such signs are made and used in great numbers because they are simple in construction and, therefore, generally inexpensive to make and maintain.

On the inside of buildings, simple signs are usually easy to read because they are illuminated or capable of being illuminated by unattached nearby light fixtures or lamps.

Often, simple signs on the outside of buildings are not illuminated and become difficult or impossible to read as it gets dark. In many cases, one would not know that a sign is present in a given location if it is not illuminated. Yet, if one could read the message on the sign, it would be of great assistance when looking for a street address, for example. Thus, there is a need for a comparatively simple, inexpensive sign that is not illuminated but which has enhanced ambient light collecting features thus improving readability as compared with most signs presently in use.

### BRIEF SUMMARY OF THE INVENTION

To overcome some of the disadvantages referred to above, applicant has devised a sign that is not illuminated but which utilizes ambient light to provide a sign that is more readable in lower light conditions than the unlighted signs presently in use,

The sign of the present invention utilizes a stacked assembly consisting of:
1) a bottom layer having a shiny, reflecting surface which could be a mirror but which also could be a coated glass, metal or plastic sheet or coated film, all having a shiny, reflecting surface;
2) a layer of prismatic material, such as clear plastic with a regular or irregular pattern molded, cast or embossed or etched on its surface
3) a faceplate having a message which is transparent or cut out to expose the prismatic layer and an opaque background or vice versa, and
4)a protective layer of transparent material which could be a film, glass or clear plastic, such as Lexan, This layer is preferably manufactured or coated with an ultraviolet protective material and/or an abrasion-resistant material and/or a graffiti-resistant material or a combination of these protections.

A combination of the above layers in placement order other than described above can also produce enhanced readability of signs.

It has been found that a layer of prismatic acrylic material having a regular or irregular surface placed next to a highly reflecting surface is very effective to gather and reflect light. By placing a faceplate containing a desired message over the prismatic layer with the message either transparent with an opaque background or vice versa, any ambient light is enhanced and reflected back through the transparent layer while contrasting vividly with the opaque background or surrounding material.

The second layer described above is preferably of a clear acrylic having a regular or irregular surface which has numerous angles and elevations. One successful acrylic material has a totally random or irregular surface. The second layer above described may have one side coated to enhance its reflective qualities; this would obviate the need for the first lamination layer described above

The third layer preferably consists of a layer of plastic film that is secured to the smooth upper surface of the second layer. the third layer could also be of paper or other rigid or flexible sheet material having opaque portions and other portions which are transparent or cut out.

A sign formed of the above-described layers stacked as described remains legible even in very low light. Even after dark, the ambient light from various sources of artificial light around a populated area is sufficient to render the described sign readable.

The sign may be of any shape, regular or irregular on the periphery and can be concave or convex or in any moldable or formed shape on the sign face plane. Different color layers may be used to enhance the visual effect.

The plates to be laminated may be joined together using clear glue, plastic coatings, Radio Frequency Welding or using nuts, bolts or screws, The edges may be held together by inserting the plates into molded or extruded members made of plastic, metal or any other material that is moldable or can be extruded or formed to hold the plates together, with or without air gaps between the plates

### BRIEF DESCRIPTION OF THE DRAWING(S)

This invention may be more clearly understood with the following detailed description and by reference to the drawings in which the stacked plates are as follows:

FIG. 1

30 Mirror or Reflective Plate, used to reflect light entering through Protection Plate 40

32 Prismatic Plate used to enhance the light entering the sign

36 Legend Plate used to carry the message to be displayed by the sign

40 Protection Plate used to strengthen and keep sign readable.

FIG. 1a shows a side view of plates that may have a convex or concave surface.

FIG. 2,

31 Prismatic plate coated on smooth side to reflect light entering through Protective plate 40.the prismatic side of this plate enhances the light traveling through the plate to the rear coating where it is reflected back through the sign.

36 Legend Plate used to carry the message to be displayed by the sign

40 Protection Plate used to strengthen and keep sign readable.

FIG. 3 is an exploded view of stacked plates shown in FIG. 1

FIG. 4 is an exploded view of stacked plates shown in FIG. 2

FIG. 5 is an example of different shapes that may be used on the outside profile of the sign

### DETAILED DESCRIPTION OF THE PREFERRED EMBODIMENT

FIG. 1. Shows the top view of the stacked assembly, plate marked 30 is the rear protective plate that is shiny on the side adjacent to the prismatic plate 32, the prismatic surface 34 of this plate is stacked adjacent to the legend plate marked 36, the plate marked 36 carries the message of the sign, the final layer 40 is the plate to protect the exposed area of the sign, this plate would be used to increase the rigidity of the sign in the case of plates,30 ,32, 36 or a combination of these plates being film or non-rigid material. The faces of the laminated plates in FIG. 1 may be concave, convex or any shape capable of transmitting light, The outside edges may be of any shape to form a graphic design or logo.

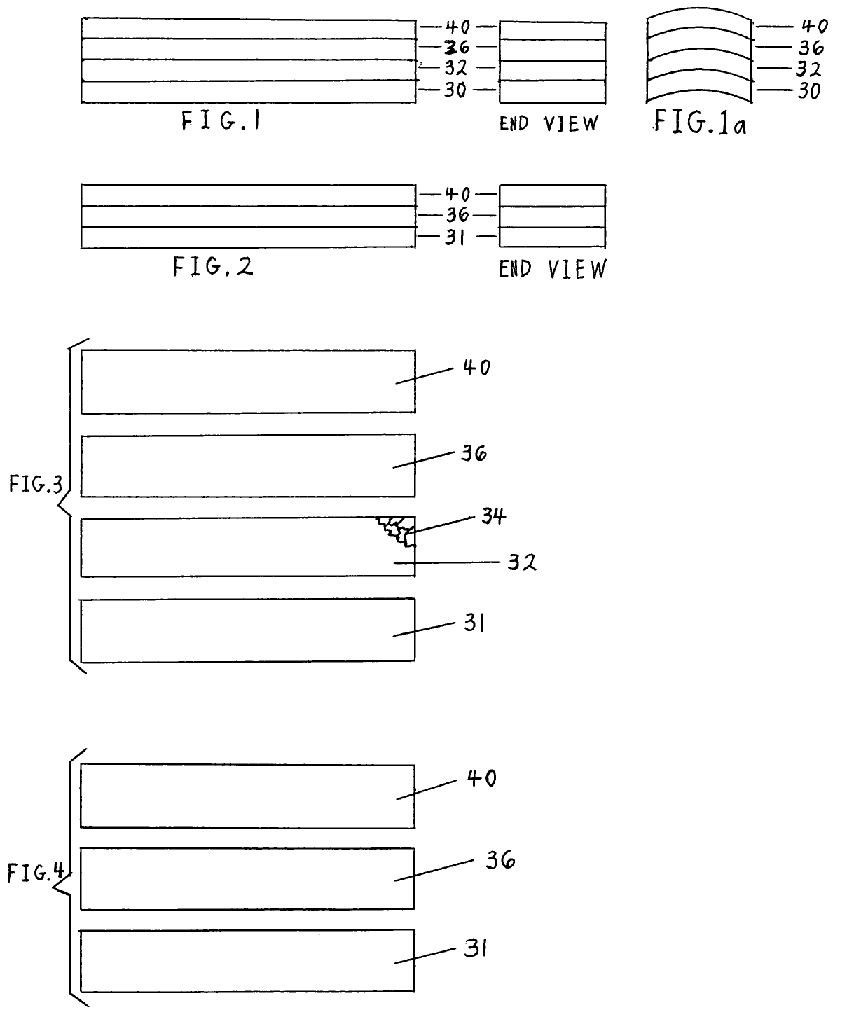

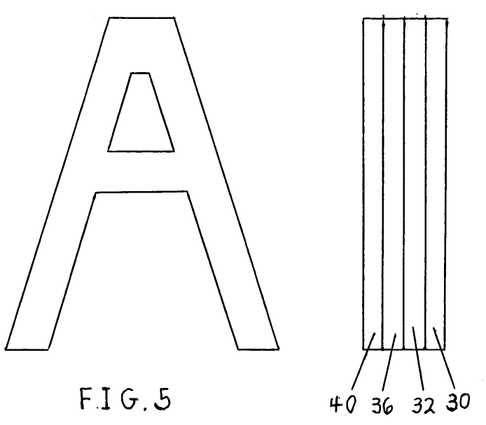

FIG. 2 shows the top view of an alternative stacked assembly of a three plate sign. The plate marked 31 is a prismatic plate with a coated finish on the flat side, this plate is stacked prismatic side to the legend plate 36 which is stacked next to the protection plate marked 40 in FIG. 2. The faces of the laminated plates in FIG. 2 may be concave, convex or any shape capable of transmitting light, The outside edges may be of any shape to form a graphic, design or logo. FIG. 3 it will be seen that four layers are shown in an exploded, perspective view. The bottom layer 30 is a plate which could be a mirror but preferably is a polished or electro plated sheet of material, such as aluminum or stainless steel, or plastic which has a high degree of reflectivity. The second layer 32 is a prismatic material, such as a sheet of clear prismatic plastic material having an irregular or regular surface providing a very large number of surfaces of many angles. One such material is a sheet of acrylic material having a surface identified as “Cracked Ice Clear” from Plaskolite, Inc. of Columbus, Ohio. A small section 34 of material having a similar regular or irregular surface is shown on layer 32. The regular or irregular surface 34 is preferably placed adjacent the reflecting surface 31 of bottom layer 30.

The third layer, which is a faceplate layer 36, is preferably a film secured to the top, smooth surface of layer 32 having transparent portions for the message numerals and otherwise being opaque. Alternatively, the alpha-numeric and/or graphic message can be opaque with the surrounding background areas being transparent. In either case, the message will stand out prominently if there is a significant amount of ambient light.

The fourth or top plate 40 is a protective layer of clear material, such as glass or Lexan. To further protect the sign, top plate 40 may be manufactured to include or have an exterior coating of ultraviolet, resistant graffiti release and/or abrasion-resistant material. FIG. 1a) is a side view of the assembled sign of FIG. 1 The clear acrylic layer 32 has an irregular surface shown at numeral 34 and is adjacent to the bottom layer 30 which has a highly polished or shiny surface 31. The third layer 36 may be of a plastic film that is preferably secured to the smooth top surface of top plate 40.

An advantage of the particular arrangement described above is that the space between the regular or irregular surface of the clear acrylic layer or sheet and the film layer 36 represented by the thickness of layer 32 produces a three dimensional visual effect which enhances the display.

The above-described embodiments of the present invention are merely descriptive of its principles and are not to be considered limiting. The scope of the present invention instead shall be determined from the scope of any claims in a corresponding non-provisional application, including their equivalents.

FIG. 4 is an exploded view of the faces as described in FIG. 2.

FIG. 5 is the front and side view of a sign cut to a shape, this shape may be of any contour and the plates although shown as a four plate sign may be of a three plate design as shown generally in FIG. 2.

1. A sign comprising a first layer including a reflecting surface, a second layer adjacent said first layer of prismatic material, a third layer consisting of a film layer including a message and a clear, protective layer over said film layer.

2. A sign as claimed in claim 1 wherein said clear, protective layer includes ultraviolet resistant material.

3. A sign as claimed in claim I wherein said clear, protective layer is abrasion resistant.

4. A sign as claimed in claim 1 wherein said first layer comprises a metal or plastic sheet having a polished or electroplated surface.

5. A sign as claimed in claim I wherein said prismatic material is of clear Acrylic having a regular or irregular surface.

6. A sign as claimed in claim 1 wherein said prismatic material is of clear glass having a regular or irregular surface.

7. A sign as claimed in claim 1 wherein said prismatic material is of clear plastic having a regular or irregular surface.

8. A sign as claimed in claim 1 wherein said layer comprises a mirror.

9. A sign for conveying a message comprising a plurality of stacked layers including a first layer having a reflecting surface, a smooth surface and adjacent said first layer. a faceplate containing a message adjacent said second layer, said faceplate including transparent and opaque areas defining said message, and a protective top plate of clear material.

10. A sign as claimed in claim 9 wherein said faceplate comprises a film layer secured to the smooth surface of said second layer.

11. A sign as claimed in claim 10 wherein said film layer includes a transparent portion defining a message and an opaque portion.

12 A sign as claimed in claim 10 wherein said film layer includes a transparent portion defining a message and an opaque portion and an opaque portion defining a message.

13. A sign as claimed in claim 18 wherein said second layer is installed with its irregular surface facing said reflecting surface and said faceplate is positioned adjacent said smooth surface.

14. A sign as claimed in claim 9 wherein said first layer comprises a metal sheet having a polished or electro-plated surface.

15. A sign as claimed in claim 9 wherein said first layer comprises a plastic sheet having a polished or electro-plated surface.

16. A sign as claimed in claim 9 wherein said first layer comprises a glass sheet having a mirrored or reflecting or electro-plated surface.

17. A sign as claimed in claim 9 wherein said protective top plate is of clear plastic material.

18. A sign as claimed in claim 9 wherein said protective top plate includes a coating of ultraviolet light resistant material.

19. A sign as claimed in claim 9 wherein said protective top plate is manufactured to include an ultraviolet light resistant component.

20. A sign as claimed in claim 9 wherein said protective top plate has an abrasion-resistant coating.

21. A sign as claimed in claim 9 wherein said protective to plate is manufactured to include an abrasion-resistant component.

22. A sign for conveying a message comprising a plurality of stacked layers including a first layer having a reflective surface, a second layer adjacent said first layer of clear acrylic t iprismatic material, and a smooth surface, a faceplate containing a message, said faceplate including transparent and opaque areas defining said message, and a protective top plate of clear material.

23. A sign comprising of a first layer of prismatic material coated on the smooth side with the irregular side adjacent to the second layer which includes a message and a clear protective layer over message layer.

24 A sign consisting of multi layers convex, concave, or angular shaped on sign face and/or the outside edges of irregular or regular shape.
Although illustrated and described herein with reference to certain specific embodiments, the present invention is nevertheless not intended to be limited to the details shown. Rather, various modifications may be made in the details within the scope and range of equivalents of the claims and without departing from the spirit of the invention.
